(19) United States
(12) Patent Application Publication
(10) Pub. No.: US 2002/0019779 A1
(43) Pub. Date: Feb. 14, 2002

(54) Interactive order processing system and method for global computer network commerce

(76) Inventors: Timothy G. Healey, Winchester, MA (US); Sanjay K. Bajpai, Leawood, KS (US)

Correspondence Address: SHUGHART THOMSON & KILROY, P.C., 120 West 12th Street, Kansas City, MO, 64105, US

(21) Appl. No.: 09/873,028

(22) Filed: Jun. 1, 2001

Related U.S. Application Data
(60) Provisional application No. 60/209,270, filed on Jun. 2, 2000.

(51) Int. Cl. G06F 17/60

(52) U.S. Cl. 705/26

(57) ABSTRACT

An interactive order processing system includes a front-end module for receiving orders. The front-end module can be linked to the global computer network. A back-end module is provided for updating a product/service menu listing. A computer controls the front-end and back-end modules. A method is provided for interactively processing orders via the global computer network.

### CROSS-REFERENCE TO RELATED PATENT APPLICATION

Cross-Reference to Provisional U.S. patent application Ser. No. 60/209,270, filed Jun. 2, 2000.

### BACKGROUND OF THE INVENTION

1. Field of the Invention

The present invention relates generally to methods and systems for processing orders interactively utilizing the global computer network.

2. Description of the Prior Art

The range of businesses doing business on the global computer network (i.e., “Internet”) continues to rapidly expand. Many traditional site-specific businesses are expanding their markets and reaching new customers by making available their goods and services on the global computer network.

An example of a traditional industry taking advantage of the global computer network can be found in the food services industry. For example, many restaurants have created websites for promoting their services via the global computer network. Such websites can be informational only, i.e. non-interactive. Alternatively, interactive websites are used by many businesses for taking customers' orders, confirming reservations, etc.

A significant disadvantage to restaurant-specific websites relates to the costs associated with creating and maintaining same. Such costs can be prohibitive for individual dining establishments. However, notwithstanding the significant expenses associated with a website, many businesses are faced with the necessity of promoting their services via the global computer network in order to remain competitive and maintain customer visibility.

In the case of nation-wide franchises and chains, website expenses per restaurant tend to be relatively low when allocated among large numbers of establishments. However, an individual establishment can find itself hard-pressed to compete with larger chains and franchises in e-commerce due to the extra expenses associated with creating and maintaining a website.

The prior art includes websites with multiple eating establishments and individual websites that have been developed with online ordering capabilities. Such websites can be interactive and operate by forwarding the orders to the individual restaurant members and subscribers. There are a number affirms currently providing Internet based food-ordering services to restaurants from customer portal sites. These websites typically list restaurant menus and allow consumers to process orders from electronic menus for takeout and delivery meals.

A disadvantage to the restaurant owner of the customer portal site relates to the multiple separate eating establishments which are typically displayed on such websites. Restaurant owners/ managers would prefer to promote their own websites rather than customer portal websites which may contain many other competitive restaurants. Potential customers are often confronted with competing choices from among various dining establishments on such websites. Thus, restaurant owners tend to be understandably reluctant to share websites with their competitors. A preferable solution for the restaurant owner wanting to process online orders for takeout and delivery meals would be to retrofit, change or convert a static, non-interactive website to an Internet-based software that facilitates online ordering. Restaurants would prefer an affordable system and technology to receive online orders for takeout or delivery meals on their own websites. However, building custom websites capable of processing online orders for takeout and delivery meals can be very expensive. Currently the most affordable way for restaurants to process online orders is by posting their menus on select consumer portal sites that provide online ordering services to multiple restaurants. Restaurants typically pay a service fee for every online order that they receive from an ordering service. Restaurant personnel often will encourage their customers to place meal orders from these consumer portal sites.

Brand-development is an important objective of businesses engaged in e-commerce, which can be accomplished by building brand recognition and customer loyalty with commercial messages broadcast via the Internet. Brand-development efforts are compromised by multiple-business shared websites, such as those described above.

Heretofore there have not been available methods and systems for processing orders interactively via the global computer network with the advantages and features of the present invention.

### SUMMARY OF THE INVENTION

In the practice of the present invention, a method and system are provided for interactively processing orders via the global computer network. From a link button customers link to a website including a menu page and item details. Orders are viewed, entered, submitted and confirmed. They system and method compile demographic information regarding the customers. Such information can be useful to businesses in direct marketing efforts for maximum effect. The system can convert a non-interactive/non e-commerce website into an interactive/e-commerce website, which can process online orders from an electronic menu for takeout and delivery of meals. The software technology can also be applied to websites outside of the restaurant industry. Any non-interactive/non-e-commerce business website can be converted to an interactive/e-commerce website capable of processing orders for multiple products.

### PRINCIPLE OBJECTS AND ADVANTAGES OF THE INVENTION

The principle objects and advantages of the present invention include: providing a system and method for interactively processing orders via the global computer network; providing such a system and method which seamlessly connect potential customers with websites of commercial enterprises; providing such a system and method which are adapted for converting non-interactive/non-e-commerce business websites into interactive/e-commerce websites capable of processing orders for multiple products and/or services; providing such a system and method which are “brand-preserving” for members and subscribers; providing such a system and method which are seamless in integrating existing non-interactive websites with interactive websites; applying interactive ordering functionality for members' and subscribers' current interactive websites; providing automated extranet capabilities for member/subscriber personnel to modify website content and update listings of goods and services; providing back end order processing applications for use on existing web pages; processing orders for goods and services from existing websites; providing a less expensive alternative as compared to creating and maintaining a single-purpose, custom website; providing links which can be quickly and easily established; improving sales order volumes of members and subscribers; allowing members and subscribers to handle orders from their own websites and to promote their own brand names; providing such a system and method which are adaptable for various industries, including the restaurant industry; and providing such a method and system which are efficient in operation and particularly well adapted for the proposed usage thereof.

### BRIEF DESCRIPTION OF THE DRAWINGS

FIG. 1 is a flowchart showing the operation of a prior art on-line restaurant ordering system and method.

FIG. 2 is a flowchart showing the function of a front end/order processing module of the system and method of the present invention.

FIG. 3 is a flowchart showing the function of a back end product/service listing update module of the system and method of the present invention.

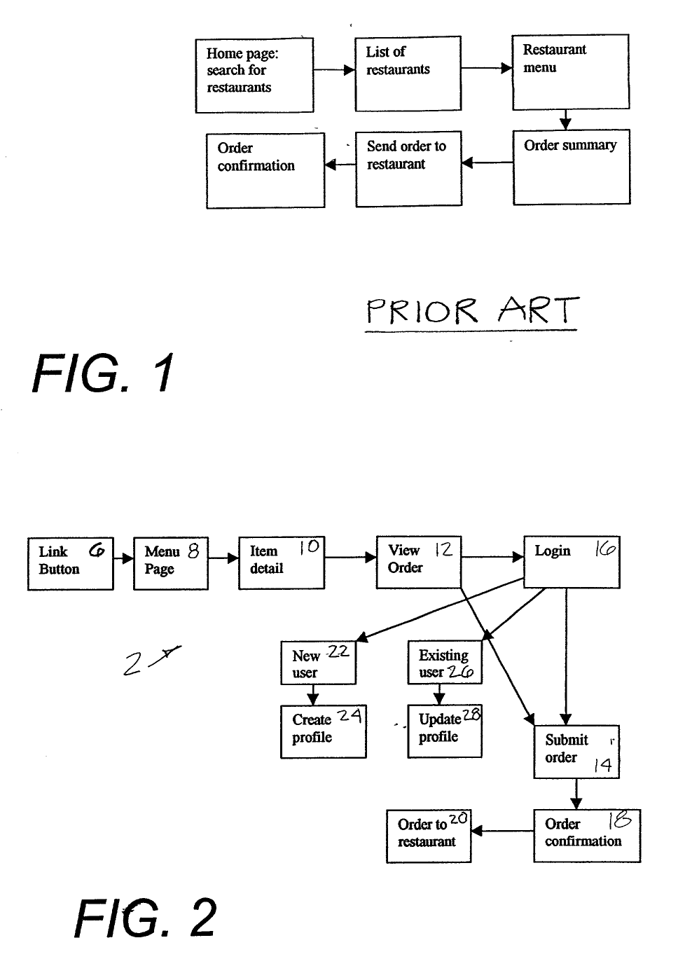

### DETAILED DESCRIPTION OF THE PREFERRED EMBODIMENTS

I. Introduction and Environment

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

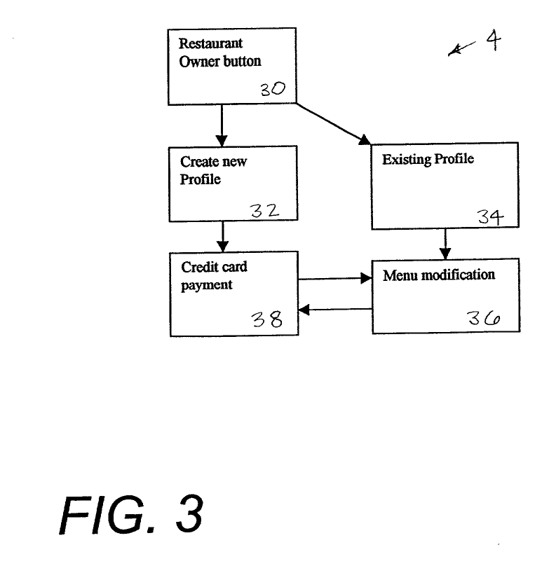

Referring to the drawings in more detail, an interactive order processing system for global computer network commerce generally comprises a front end/order processing module (FIG. 2) and a back end/menu update module 4 (FIG. 3).

II. Front End Module 2

The front end module 2 interactively interfaces with the customers. Customers access the website through a link button 6 to a menu page 8 which provides item detail at 10. Customers can view their orders at 12 and, alternatively, either submit their orders directly at 14 or initiate a login procedure, such as to a customer account at 16, and then proceed to submitting an order at 14. Order confirmation occurs at 18 and it is transmitted to a restaurant at 20.

Customer and account profile information can be extracted from the login step at 16. New users (customers) are routed to a new user step 22 for profile creation at 24 and existing users (customers) are routed to an existing user step 26 for updating their profiles at 28.

III. Back End Module 4 (FIG. 3)

FIG. 3 shows an extranet back end module for updating a product/service menu listing. The module 4 includes a button 30 for the business (e.g., restaurant) to interface with customers. New customers create new profiles at 32 and existing customers modify their existing profiles at 34. Menu modification of existing profiles occurs at 36. Both the new profile creation step 32 and the menu modification step 36 interface with a credit card payment step 38. Customer demographic and profile information can be extracted from the system for use by the members/subscribers in focusing marketing and advertising efforts.

IV. Programming Languages

The system and method embodying the present invention can be programmed in any suitable language and technology, such as, Hypertext Markup Language (HTML), Active ServerPages (ASP) and Javascript. Alternative versions maybe developed using other programming languages including, but not limited to: C++; Visual Basic; Java; VBScript; Jscript; BCMAscript; DHTM1; XML and CGI. Any suitable database technology can be employed, but not limited to: Microsoft Access and IMB AS 400.

V. Application

Without limitation on the generality of useful applications of the system and method of the present invention, virtually any type of commerce involving order processing via the global computer network can utilize the present invention to advantage. In addition to the restaurant industry, various other industries involving the ordering of goods and services can be adapted to this method and system. In particular, separate and distinct retail businesses can maximize brand-investing and customer identification by linking to an Internet access provider which is in a position to handle multiple subscribing merchant accounts at reasonable costs and simultaneously maintain their separate identities.

It is to be understood that while certain forms of the present invention have been illustrated and described herein, it is not to be limited to the specific forms or arrangements of components and/or steps described and shown.

What is claimed in the present invention is as follows:

1. An interactive order processing system and method for global computer network commerce, which includes:
(a) a front-end module for interfacing with customers;
(b) a back-end module connected to the front-end module and adapted for updating product/service menus; and
(c) a computer controlling said front-end and back-end modules and being preprogrammed to process orders received by said front-end module.
